(19) United States
(12) Patent Application Publication
(10) Pub. No.: US 2009/0188125 A1
(43) Pub. Date: Jul. 30, 2009

(54) CONDITIONING ATTACHMENT FOR HAIR DRYER

(76) Inventor: KAM FAI FUNG, Tuen Mun (HK)

Correspondence Address: Lawrence Cruz;Conair Corporation, One Cummings Point Road, STAMFORD, CT, 06902, US

(21) Appl. No.: 12/358,434

(22) Filed: Jan. 23, 2009

Related U.S. Application Data
(60) Provisional application No. 61/023,607, filed on Jan. 25, 2008.

(51) Int. Cl. F26B 19/00; A45D 20/12

(52) U.S. Cl. 34/68; 34/97

(57) ABSTRACT

An attachment 1 is attached to a nozzle of a hand held hair dryer. The attachment 1 has a hollow, generally tubular body 2 to direct the heated air flowing out of the dryer through the attachment 1. The distal end 4 includes a grill 5 that is attached to a collar section 6 part of the body 2. A central container 7 is concentrically suspended within the collar section 6 via struts 8 that allow air from the dryer to flow past the container 7 within the collar 6. As air flows past the container 7, it engages a fan 11 in the form of a blade that is rotatably mounted to a hub assembly formed by a bracket 12 and a cap 13 that covers the container 7. As heated air flows out of the hairdryer, the air flow drives the fan 11 rotationally and causes centrifugal forces to be applied to the liquid conditioner that is present in the cap 13 section of the enclosure formed by the cap 13 and container 7. The centrifugal force causes the liquid conditioner to be dispersed out of the nozzle openings 15 and into the air emitted for drying hair.

### CROSS-REFERENCE TO RELATED APPLICATIONS

This application relates to and claims priority from U.S. Provisional Application No. 61/023,607, filed on 25 Jan. 2008.

### BACKGROUND OF THE INVENTION

1. Field of the Invention

The present invention relates to personal beauty appliances and, more particularly, to hand held hair drying appliances for drying and styling hair.

2. Description of Related Art

Various known appliances exist for drying hair exist. Certain hand held hair dryers include feature for infusing a scent or conditioning particles into the flowing air stream exiting the nozzle. For example, at least one known device includes a nozzle attachment to which is mounted a coated flat plate in the path of the air stream. Such devices are limited in the amount of particle that can be coated on the plate and subsequently infused into the air stream. Thus, the longevity of the plate's coating and the rate at which it infuses particles is minimal.

### OBJECTS OF THE PRESENT INVENTION

It is an object of the present invention to provide an attachment for a hand held dryer for infusing conditioning particles or mist into the flow path of an exiting air stream that achieves higher performance than known devices.

These and other objects are achieved by the present invention.

### BRIEF DESCRIPTION OF THE DRAWINGS

FIG. 1 is a front view of a hair dryer attachment according to the present invention.

FIG. 2 is a side view of a hair dryer attachment according to the present invention.

FIG. 3 is a perspective view of a hair dryer attachment according to the present invention.

FIG. 4 is a bottom view of a hair dryer attachment according to the present invention.

FIG. 5 is a partial, exploded view of a hair dryer attachment according to the present invention.

FIG. 6 is another partial, exploded view of a hair dryer attachment according to the present invention.

FIG. 7 is a side, cross-sectional view of a hair dryer attachment according to the present invention.

FIG. 8 is another side, cross-sectional view of a hair dryer attachment according to the present invention.

FIG. 9 is a diagrammatic, partial, perspective view of a hair dryer attachment according to the present invention.

### DETAILED DESCRIPTION OF THE PREFERRED EMBODIMENTS OF THE INVENTION

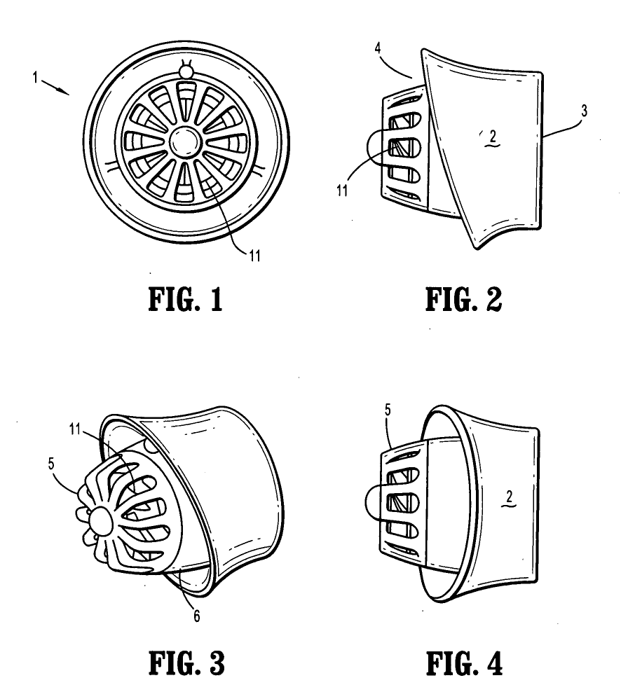

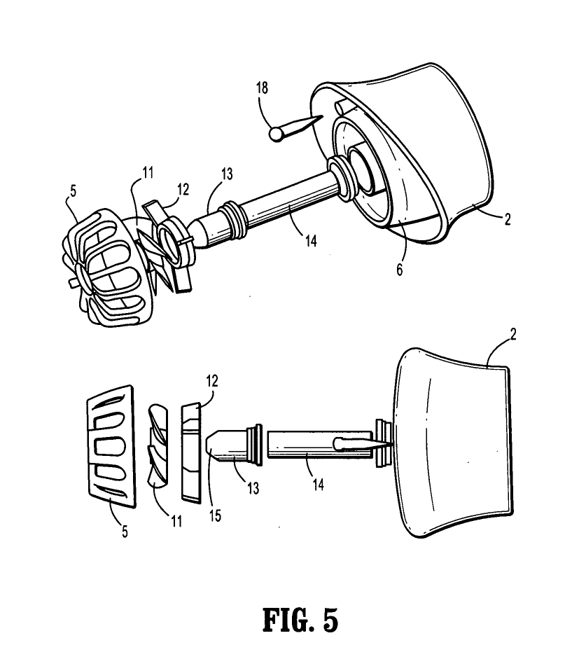

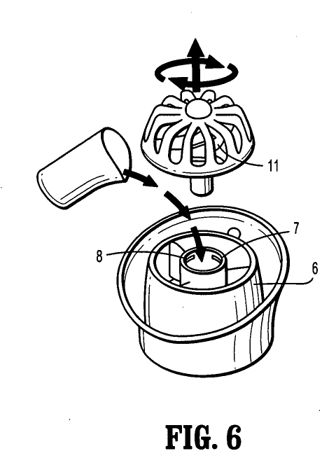

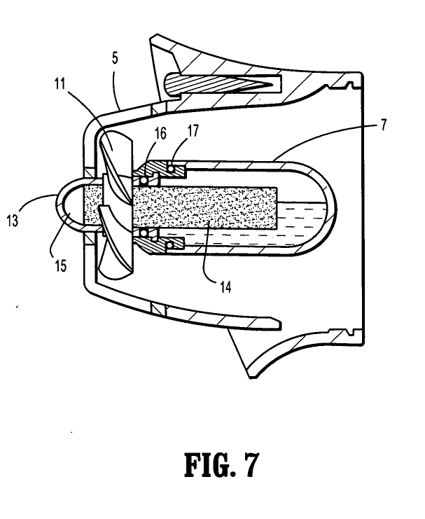

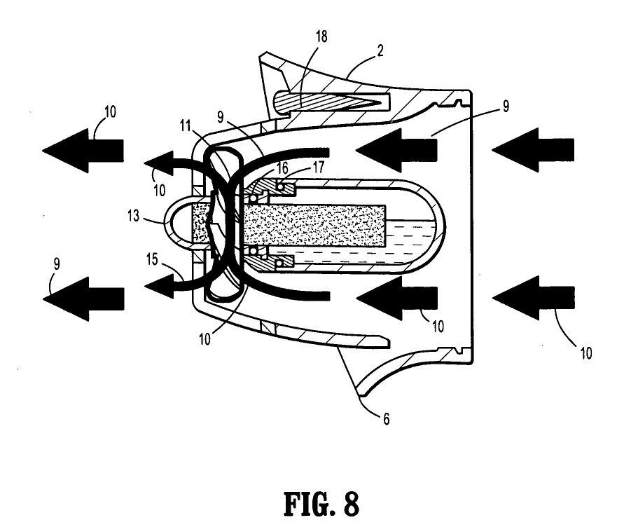

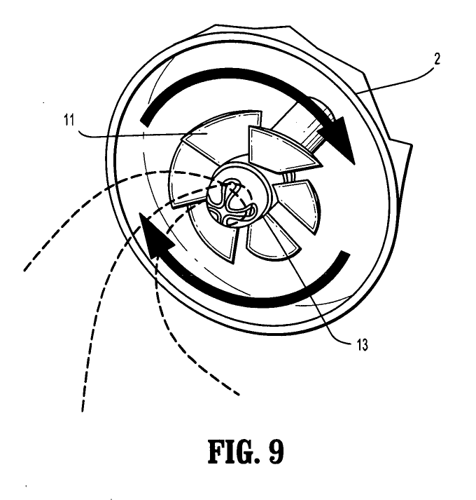

Referring to FIGS. 1-9, an attachment 1 according to the present invention is adapted to be removably attached to a nozzle of a conventional hand held hair dryer. The attachment 1 has a hollow, generally tubular body 2 comprising a proximal end 3 and a distal end 4. The proximal end 3 is adapted to be attached to the nozzle end of a conventional hand held hair dryer by press fit or other means, in a manner to direct the heated air flowing out of the dryer through the attachment 1. The distal end 4 includes a grill 5 that is removably attached to a collar section 6 molded as part of the body 2. A central container 7 is concentrically suspended within the collar section 6 via struts 8 that allow air from the dryer to flow past the container 7 within the collar 6, as shown by the air flow paths 9, 10. As air flows past the container 7, it engages a fan 11 in the form of a blade that is rotatably mounted to a hub assembly formed by a bracket 12 and a cap 13 that covers the container 7.

In use, the grill 5 is removed and lifted out. The fan 11 and hub assembly are lifted with the grill 5. The container 7 is filled with a liquid such as a conditioner for hair. An elongated sponge 14 is placed into the container 7 and is adapted to provide a wicking action to bring the liquid toward the cap 13. The cap 13 has one or more nozzle openings 15 located on the circumferential wall of the cap 13. The cap 13 is mounted to the container 7 via one or more bearing assemblies 16, 17 so that the cap 13 can rotate relative to the container 7. The cap 13 is mounted to the fan 11 so that it rotates therewith.

As heated air flows out of the hairdryer under normal operation, the air flow drives the fan 11 rotationally, so that the cap 13 rotates with the fan 11. Such rotation causes centrifugal forces to be applied to the liquid conditioner that is present in the cap 13 section of the enclosure formed by the cap 13 and container 7. The centrifugal force causes the liquid conditioner to be dispersed out of the nozzle openings 15 and into the air emitted for drying hair. A cleaning pin 18 may be provided and is used to clear debris or dried conditioner or product from the one or more nozzle openings 15.

While the preferred embodiments have been shown and described, various modifications can be made without departing from the scope of the present invention.

What is claimed is:

1. An attachment adapted to be removably attached to an elongated, barrel-shaped nozzle of a conventional hand held hair dryer, said attachment comprising
a hollow, generally tubular body comprising a proximal end and a distal end, the proximal end being adapted to be attached to the end of a nozzle of a conventional hand held hair dryer to permit flowing air emitted from said dryer to pass through said tubular body;
a container attached to said tubular body and suspended concentrically within said tubular body and adapted to be filled with liquid;
at least one opening in said container; and
a fan blade assembly rotatably mounted to said attachment in the path of flowing air emitted from said dryer and adapted to rotate in response to said flowing air, whereby rotational movement of said fan blade assembly creates air pressure that draws said liquid out of said container through said at least one opening such that said liquid passes through said tubular body with said flowing air as it passes through said tubular body.

2. An attachment according to claim 1, wherein
said tubular body is adapted to be attached to a nozzle of a conventional hair dryer by press fit.

3. An attachment according to claim 1, further comprising
a grill that is removably attached to said distal end of said attachment and having a plurality of openings to permit air to pass therethrough.

4. An attachment according to claim 1, further comprising
a sponge adapted to be placed in said container to draw liquid placed in said container toward said at least one opening using a wicking action.

5. An attachment according to claim 1, further comprising
an end cap mounted to said blade assembly for rotation therewith, and a bearing adapted to rotationally mount said end cap and said blade assembly to said container such that said end cap and said blade assembly are rotatable relative to said container.

6. An attachment according to claim 5, further comprising
at least one end cap opening in said end cap to enable liquid to pass through said end cap opening from within said container.
